(19) United States
(12) Patent Application Publication
(10) Pub. No.: US 2015/0120410 A1
(43) Pub. Date: Apr. 30, 2015

(54) SYSTEM AND METHOD FOR IDENTIFYING INELASTIC PRODUCTS

(71) Applicant: WAL-MART STORES, INC., Bentonville, AR (US)

(72) Inventors: Rahul Chowdhury, Rogers, AR (US); Charles Brandon Fletcher, Bentonville, AR (US); Caroline Conway, Bentonville, AR (US)

(73) Assignee: WAL-MART STORES, INC., Bentonville, AR (US)

(21) Appl. No.: 14/063,090

(22) Filed: Oct. 25, 2013

(51) Int. Cl. G06Q 30/02

(52) U.S. Cl. CPC G06Q 30/0211
USPC 705/14.13

(57) ABSTRACT

According to one aspect, embodiments of the invention provide a system for identifying inelastic products, the system comprising an interface, a markdown analysis module, and a database, wherein the markdown analysis module is further configured to receive signals from each server of a plurality of retail stores including product sales information, calculate, based on the received information, the total expected markdown for each retail store, identify, based on the total expected markdown of each retail store, an outlier store that has a total expected markdown greater than a threshold, identify a sister store that has at least one similar characteristic to the outlier store and less total expected markdown than the outlier store, compare expected markdowns of the outlier store and the sister store, and identify, based on the comparison between the expected markdowns of the outlier and sister stores, at least one inelastic product in the outlier store.

### BACKGROUND OF THE DISCLOSURE

1. Field of the Invention

Aspects of the present invention relate to a system and method for identifying “inelastic” products in a retail environment.

2. Discussion of Related Art

Retailers typically utilize markdowns to generate interest in certain items within their stores. A markdown is a reduction in the selling price of an item which is intended to stimulate or drive a consumer to purchase the item. Markdowns may be temporary or permanent. Markdowns are commonly used by retailers to drive interest in a slow-selling, new, or overstocked item. For example, if a retailer wishes to generate interest in an item that is not currently selling at desired levels, the retailer may temporarily markdown the price of the item to entice customers to purchase the item. After a period of time, or after a certain number of sales, the retailer may remove the markdown and return the item to its original price.

### SUMMARY

Embodiments described herein provide a system and method for analyzing and identifying “inelastic” products in a retail environment. As defined herein, a product for sale in a retail environment is classified as an “inelastic” product when the sales of the product are not affected by (or inelastic to) a current price markdown, regardless of the time and/or level of the price markdown. By comparing markdowns of an “outlier” store to a “sister” store with similar characteristics, a retailer may be able to quantitatively identify inelastic products in the outlier store. As defined herein, a store within a group of stores is classified as an “outlier” store when the expected total markdown of the store is higher than the expected total markdown of a majority of other stores in the group. As defined herein, a store within a group of stores is classified as a “sister” store to an outlier store in the group when the store has similar sales and similar characteristics to the outlier store but less expected total markdown.

Once an inelastic product is identified in a store, the markdown of the inelastic product may be adjusted to provide greater return to the retailer. For example, according to one embodiment, the markdown of the inelastic product may be adjusted to bring the current price of the item more in line with a base price of the inelastic product, which will provide greater return to the retail store while maintaining relatively stable sales of the inelastic product.

According to at least one embodiment described herein, a system that is a tool for managers of a retail environment (including multiple retail outlets) to perform real-time analysis of product sales and pricing at the multiple retail outlets is provided. The tool automatically compiles product sales and pricing information from a server at each retail outlet within the retail environment, analyzes the product sales and pricing information, and based on the product sales and pricing information from each retail outlet, identifies inelastic products for sale at at least one of the retail outlets. In at least one embodiment described herein, upon identifying an inelastic product, the tool automatically acts to adjust the price of the identified inelastic product at a retail outlet to a level that will provide a greater return to the retailer upon sale of the product. Such a system for the real-time analysis of the current markdowns of products may allow managers of a retail environment to identify bad markdown strategies and make appropriate adjustments.

For example, aspects in accord with at least one embodiment of the present invention are directed to a system for identifying inelastic products in a retail environment, the system comprising an interface configured to be coupled to a communication network, a markdown analysis module coupled to the interface and configured to communicate with a server of each one of a plurality of retail stores in the retail environment via the interface and the communication network, and a database coupled to the markdown analysis module, wherein the markdown analysis module is further configured to receive signals from each server of the plurality of retail stores including information related to product sales in each one of the plurality of retail stores, calculate, based on the received product sales information, the total expected markdown over a period of time for each one of the plurality of retail stores, identify, based on the total expected markdown of each one of the plurality of retail stores, an outlier store from the plurality of retail stores that has a total expected markdown greater than a expected total markdown threshold, identify a sister store from the plurality of retail stores that has at least one similar characteristic to the outlier store and a total expected markdown that is less than the total expected markdown of the outlier store, compare expected markdown of the outlier store with expected markdown of the sister store, and identify, based on the comparison between the expected markdown of the outlier store and the sister store, at least one inelastic product in the outlier store.

According to one embodiment, the product sales information received by the markdown analysis module from each one of the plurality of retail stores includes at least one of product and sale based factors that impact the total expected markdown of the plurality of retail stores. In one embodiment, in calculating the total expected markdown over the period of time for each one of the plurality of retail stores, the markdown analysis module is further configured to perform a regression analysis for the expected markdown of each one of the plurality of retail stores over the period of time based on the received product or sale based factors of each one of the plurality of stores.

According to another embodiment, in comparing the expected markdown of the outlier store with the expected markdown of the sister store, the markdown analysis module is further configured to compare differences between expected markdown in a plurality of departments in the outlier store and expected markdown in the plurality of departments in the sister store. In one embodiment, the markdown analysis module is further configured, based on the comparison of differences between the expected markdown in the plurality of departments in the outlier store and the expected markdown in the plurality of departments in the sister store, to identify a department of opportunity in which the difference between the expected markdown in the outlier store and the expected markdown in the sister store is greater than a department level expected markdown threshold. In another embodiment, in comparing the expected markdown of the outlier store with the expected markdown of the sister store, the markdown analysis module is further configured to compare differences between expected markdown of products in the department of opportunity of the outlier store and expected markdown of products in the department of opportunity of the sister store.

According to one embodiment, the markdown analysis module is further configured to identify at least one product, within the department of opportunity, at which the difference between expected markdown of the at least one product in the outlier store and the expected markdown of the at least one product in the sister store is greater than a product level expected markdown threshold. In another embodiment, the markdown analysis module is further configured to confirm whether the at least one product in the outlier store is inelastic. In one embodiment, in confirming whether the at least one product in the outlier store is inelastic, the markdown analysis module is further configured to analyze at least one of total sales information of the at least one product in the outlier store and quantity sold information of the at least one product in the outlier store in relation to markdown information of the at least one product in the outlier store.

According to one embodiment, the markdown analysis module is further configured to identify the at least one product as inelastic in response to a determination that the markdown information of the at least one product in the outlier store is relatively unaffected by either the sales information or the quantity sold information of the at least one product in the outlier store. In one embodiment, the markdown analysis module is further configured to adjust a current markdown of the at least one product in the outlier store to a target level in response to a determination that the at least one product is inelastic. In another embodiment, the markdown analysis module is further configured to adjust a current price of the at least one product in the outlier store to a level that is a predefined percentage less than a preprogrammed base price of the at least one product. In another embodiment, the markdown analysis module is further configured to transmit signals, via the interface, to the server of the outlier store to adjust the current markdown of the at least one product to the target level. In another embodiment, the markdown analysis module is further configured to adjust, in real time, the current markdown of the at least one product in the outlier store to a target level in response to the determination that the at least one product is inelastic.

According to another embodiment, the system further comprises a price adjustment module coupled to the interface and the markdown analysis module and configured to communicate with the server of each one of the plurality of retail stores in the retail environment via the interface and to adjust a current markdown of the at least one product in the outlier store to a target level in response to a determination, by the markdown analysis module, that the at least one product is inelastic.

One aspect in accord with at least one embodiment of the present invention is directed to a method for identifying inelastic products in a retail environment, the method comprising receiving, by a markdown analysis module from a server of each one of a plurality of retail stores in the retail environment via an interface, signals from each server of the plurality of retail stores including information related to product sales in each one of the plurality of retail stores, calculating, with the markdown analysis module, based on the received product sales information, the total expected markdown over a period of time for each one of the plurality of retail stores, identifying, with the markdown analysis module based on the total expected markdown of each one of the plurality of retail stores, an outlier store from the plurality of retail stores that has a total expected markdown greater than a expected total markdown threshold, identifying, with the markdown analysis module, a sister store from the plurality of retail stores that has at least one similar characteristic to the outlier store and a total expected markdown that is less than the total expected markdown of the outlier store, comparing, with the markdown analysis module, expected markdown of the outlier store with expected markdown of the sister store, and identifying, with the markdown analysis module based on the comparison between the expected markdown of the outlier store and the sister store, at least one inelastic product in the outlier store.

According to one embodiment, calculating the total expected markdown over the period of time for each one of the plurality of retail stores includes generating, with the markdown analysis module, a regression model for the expected markdown of each one of the plurality of retail stores over the period of time based on the received product sales information of each one of the plurality of stores, and utilizing the regression model to determine the total expected markdown over the period of time for each one of the plurality of retail stores. In another embodiment, comparing the expected markdown of the outlier store with the expected markdown of the sister store includes comparing, with the markdown analysis module, differences between expected markdown in a plurality of departments in the outlier store and expected markdown in the plurality of departments in the sister store.

According to another embodiment, the method further comprises identifying, with the markdown analysis module based on comparing the differences between the expected markdown in the plurality of departments in the outlier store and the expected markdown in the plurality of departments in the sister store, a department of opportunity in which the difference between the expected markdown in the outlier store and the expected markdown in the sister store is greater than a department level expected markdown threshold. In one embodiment, comparing the expected markdown of the outlier store with the expected markdown of the sister store includes comparing, with the markdown analysis module, differences between expected markdown of products in the department of opportunity of the outlier store and expected markdown of products in the department of opportunity of the sister store. In another embodiment, the method further comprises identifying, with the markdown analysis module, at least one product, within the department of opportunity, at which the difference between expected markdown of the at least one product in the outlier store and the expected markdown of the at least one product in the sister store is greater than a product level expected markdown threshold.

According to one embodiment, the method further comprises confirming, with the markdown analysis module, whether the at least one product in the outlier store is inelastic. In one embodiment, confirming whether the at least one product in the outlier store is inelastic includes analyzing, with the markdown analysis module, at least one of total sales information of the at least one product in the outlier store and quantity sold information of the at least one product in the outlier store in relation to markdown information of the at least one product in the outlier store.

According to another embodiment, the method further comprises identifying, with the markdown analysis module, at least one product as inelastic in response to a determination that the markdown information of the at least one product in the outlier store is relatively unaffected by either the sales information or the quantity sold information of the at least one product in the outlier store. In one embodiment, the method further comprises adjusting a current markdown of the at least one product in the outlier store to a target level in response to a determination that the at least one product is inelastic. In one embodiment, adjusting the current markdown of the at least one product in the outlier store to a target level includes adjusting a current price of the at least one product in the outlier store to a level that is a predefined percentage less than a preprogrammed base price of the at least one product. In another embodiment, adjusting the current markdown of the at least one product in the outlier store to a target level includes transmitting signals, to the server of the outlier store, to adjust the current markdown of the at least one product to the target level. In another embodiment, adjusting the current markdown of the at least one product to a target level is automatically performed in real time in response to the determination that the at least one product is inelastic.

Another aspect in accord with at least one embodiment of the present invention is directed to a non-transitory computer-readable medium encoded with instructions for execution on a central server within a retail environment, the instructions when executed, performing a method comprising acts of receiving, by a markdown analysis module from a server of each one of a plurality of retail stores in the retail environment via an interface, signals from each server of the plurality of retail stores including information related to product sales in each one of the plurality of retail stores, calculating, with the markdown analysis module, based on the received product sales information, the total expected markdown over a period of time for each one of the plurality of retail stores, identifying, with the markdown analysis module based on the total expected markdown of each one of the plurality of retail stores, an outlier store from the plurality of retail stores that has a total expected markdown greater than a expected total markdown threshold, identifying, with the markdown analysis module, a sister store from the plurality of retail stores that has at least one similar characteristic to the outlier store and a total expected markdown that is less than the total expected markdown of the outlier store, comparing, with the markdown analysis module, expected markdown of the outlier store with expected markdown of the sister store, and identifying, with the markdown analysis module based on the comparison between the expected markdown of the outlier store and the sister store, at least one inelastic product in the outlier store.

### BRIEF DESCRIPTION OF DRAWINGS

The accompanying drawings are not intended to be drawn to scale. In the drawings, each identical or nearly identical component that is illustrated in various FIGs. is represented by a like numeral. For purposes of clarity, not every component may be labeled in every drawing. In the drawings:

FIG. 1 is a block diagram illustrating a system for identifying inelastic products in a retail environment in accordance with at least one embodiment described herein;

FIG. 2 is a flow chart illustrating a process for identifying inelastic products in a retail environment in accordance with at least one embodiment described herein;

FIG. 3 is a regression model of expected markdown for a group of retail stores in accordance with at least one embodiment described herein;

FIG. 4 is a graph illustrating the differences between the expected markdown of an outlier store and the expected markdown of a sister store at a department level in accordance with at least one embodiment described herein;

FIG. 5 is a graph illustrating the differences between the expected markdown of products within a “department of opportunity” of an outlier store and the expected markdown of products within a “department of opportunity” of a sister store in accordance with at least one embodiment described herein;

FIG. 6 is a graph illustrating an analysis of average sales, average quantity sold, and average markdown of a products in the “department of opportunity” at which the markdown differences between an outlier store and a sister store are at relatively high levels in accordance with at least one embodiment described herein;

FIG. 7 is a flow chart illustrating a process for adjusting the price of an identified inelastic product within an outlier store in accordance with at least one embodiment described herein;

FIG. 8 is graph illustrating the impact markdown reduction of an inelastic product may have on the return of an outlier store from a sale of the inelastic product in accordance with at least one embodiment described herein;

FIG. 9 is a block diagram of a general-purpose computer system upon which various embodiments of the invention may be implemented; and

FIG. 10 is a block diagram of a computer data storage system with which various embodiments of the invention may be practiced.

### DETAILED DESCRIPTION

Embodiments of the invention are not limited to the details of construction and the arrangement of components set forth in the following description or illustrated in the drawings. Embodiments of the invention are capable of being practiced or of being carried out in various ways. Also, the phraseology and terminology used herein is for the purpose of description and should not be regarded as limiting. The use of “including,” “comprising,” or “having,” “containing”, “involving”, and variations thereof herein, is meant to encompass the items listed thereafter and equivalents thereof as well as additional items.

As discussed above, retailers typically utilize markdowns to generate interest in certain items within their stores. However, it is often difficult for a retailer to determine an appropriate time, duration, and/or level of a markdown of an item to ensure that the markdown will successfully drive sales of the item. For example, a markdown initiated at an inappropriate time and/or at an inappropriate level may not drive sales of the corresponding product as intended by the retailer. In addition, sales of some products in a retail store may be immune to the effects of a markdown. For instance, the sales of some products may not be affected by the use of a markdown. Such products are referred to herein as inelastic products in that the sales of such products are not affected by (or inelastic to) a price markdown, regardless of the time and/or level of the price markdown.

Applicant has appreciated that as the sales of an inelastic product are relatively not affected by a price markdown (no matter the markdown's level), the sales of the inelastic product will remain relatively the same even if the price markdown is reduced or eliminated. Accordingly, by reducing (or eliminating) the price markdown of an inelastic product, the relatively level sales (at a higher price) of the inelastic product will produce a greater return to the retailer. For example, if an inelastic product has a current markdown price of five dollars that returns twenty-five dollars to the retailer with five sales of the product, a reduction in the markdown of the product (i.e., an increase in price) to seven dollars will return thirty-five dollars to the retailer for the same stable five sales, which are unaffected by the reduction in markdown.

Accordingly, embodiments described herein provide a system and method for identifying inelastic products in a retail environment. Once an inelastic product is identified, the markdown of the inelastic product may be adjusted to provide greater return to the retailer.

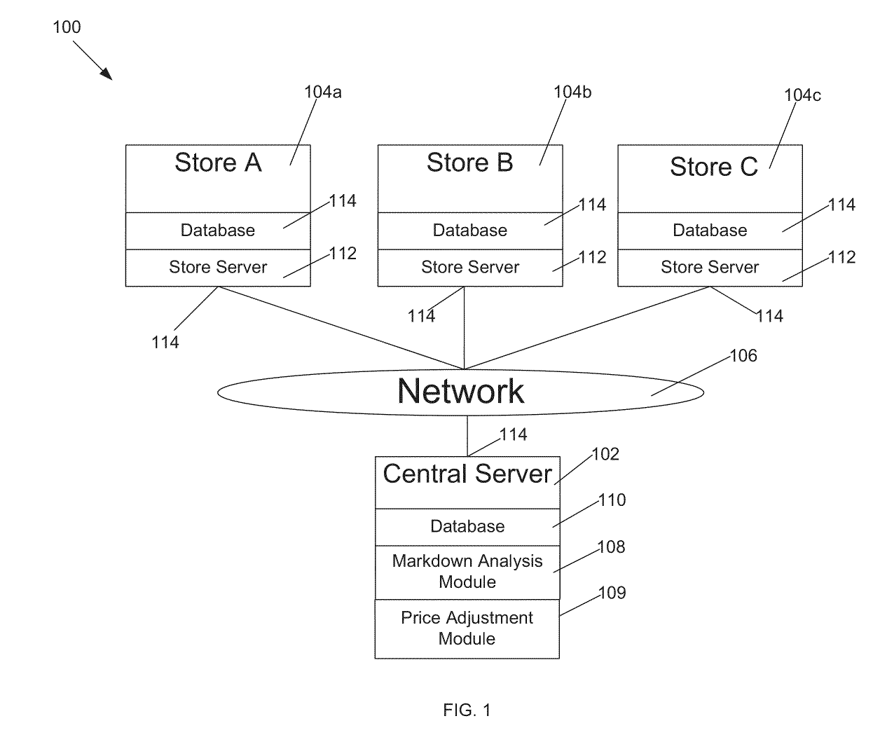

FIG. 1 illustrates one embodiment of a system 100 for identifying inelastic products in a retail environment. The system 100 includes a central server 102, a group of retail stores 104(a-c), and a network 106. The central server 102 includes a markdown analysis module 108 and a database 110. Each retail store 104(a-c) includes a store server 112 and a database 114.

Within each store 104(a-c), the store server 112 is configured to communicate with different store systems (e.g., a Point of Sale (POS) system, a store fulfillment system, an administration system, an inventory management system, etc.) to gather information related to the products offered for sale in the store and to the actual sales of products within the store. For example, according to some embodiments, the store server 112 within each store 104(a-c) gathers information from the different store systems related to the identification of different products sold within the store, the total number of sales of each type of product offered for sale within the store, the price paid for each product sold within the store, the total sales (in dollars) of each type of product offered for sale within the store, the current inventory of the different products available in the store, the current markdowns within the store, featured sales in the store, or any other information which is related to the products offered for sale within the store and/or the actual sales of the products within the store.

According to one embodiment, the store server 112 communicates with the different store systems via a Local Area Network (LAN). The store server 112 may communicate with the different store systems wirelessly or via a hardwired connection. The store server 112 maintains the gathered product and sales information in the database 114.

The markdown analysis module 108 within the central server 102 communicates with the store server 112 of each store 104(a-c) to retrieve desired information from the database 114 of each store 104(a-c) related to the products offered for sale within the store and the actual sales of the products within the store (as discussed above). According to one embodiment (as illustrated in FIG. 1), the markdown analysis module 108 is located externally from the retail stores 104(a-c) (e.g., within the central server 102 at a corporate headquarters or some other operations center). In such an embodiment, the markdown analysis module 108 (within the central server 102) communicates with the store server 112 of each store 104(a-c) via the network 106 and network interfaces 114 at the central server 102 and the store servers 112. According to one embodiment, the network 106 is the Internet; however, in other embodiments, the network 106 may be some other type of Wide Area Network (WAN) or group of networks. Also, it should be appreciated that one or more functions as described herein may be performed by one or more services distributed among one or more systems.

In another embodiment, the markdown analysis module 108 is located within one of the group of retail stores 104(a-c). For example, the markdown analysis module may be located within the store server 112 of one of the retail stores 104a. In such an embodiment, the markdown analysis module 108 may communicate with the database 114 of the store 104a within which it is located (and any other necessary store systems) via a LAN. The markdown analysis module 108 may also communicate with the store servers 108 of each other store 104(b-c) via the network 106 and network interfaces 114 (as discussed above).

Upon retrieving the desired product and sales information (related to the retail stores 104(a-c)), the markdown analysis module 108 performs a regression analysis for the expected markdown of each store 104(a-c) over a defined period of time based on multiple product and sales based factors of each store 104(a-c) that may impact or drive markdowns. For example, according to one embodiment, the markdown analysis module 108 performs a regression analysis for the expected markdown each store 104(a-c) with product and sales based factors such as total sales, feature sales, sales coefficient of variation (standard deviation/mean of weekly store sales), inventory turns, number of items in the store, the number of items actually sold, the percentage of sales that are grocery sales, or any other product or sales based factor which may affect or drive markdowns of a store.

Upon performing the regression analysis with multiple product and sales based factors for the expected markdown of each store 104(a-c), the markdown analysis module 108 generates a regression model of the total expected markdown of each store 104(a-c) over the defined period of time. Based on the calculated total expected markdown of each store 104(a-c) within the regression model, the markdown analysis module 108 identifies at least one outlier store (e.g., a store 104(a-c) with an expected total markdown that is higher than the expected total markdowns of the majority of other stores 104(a-c) in the group).

Upon identifying an outlier store, the markdown analysis module 108 identifies a sister store to the outlier store. According to one embodiment, a sister store to the outlier store is a store that has similar sales and similar characteristics (e.g., similar qualitative factors such as the same customer profiles, size, demographics, area per capita earnings, etc) to the “outlier store” but less expected total markdown.

After identifying an outlier store and an associated sister store, the markdown analysis module 108 compares the differences in markdowns between the outlier and sister stores at a department level to identify “departments of opportunity.” According to one embodiment, a “department of opportunity” is a store department within which the difference between the expected markdown of the outlier store and the expected markdown of the sister store is at a relatively high level as compared to other store departments. Applicant has appreciated that the differences in markdowns between an outlier store and a sister store at a department level generally follows Pareto's Principle in that eighty percent of the total difference in markdowns between an outlier store and a sister store is accounted for in only twenty percent of the store departments. Accordingly, by identifying departments in the two stores within which the markdown difference is at relatively high level (i.e., “departments of opportunity”), the markdown analysis module 108 is able to account for a majority of the total difference in markdowns between the outlier store and the sister store.

Upon identifying at least one “department of opportunity”, the markdown analysis module 108 identifies products within the “department of opportunity” at which the difference between the expected markdown of the outlier store and the expected markdown of the sister store is at a relatively high level as compared to other products within the “department of opportunity.” Applicant has also appreciated that the differences in markdowns between an outlier store and a sister store at a product level also generally follows Pareto's Principle in that eighty percent of the total markdown difference between an outlier store and a sister store within the “department of opportunity” is accounted for in only twenty percent of the products within the “department of opportunity.” Accordingly, by identifying products in the “department of opportunity” at which the markdown differences between the two stores are at relatively high levels, the markdown analysis module 108 is able to account for a majority of the total difference in markdown between products of the outlier store and the sister store within the “department of opportunity.”

Once the products in the “department of opportunity”, at which the markdown differences between the two stores are at relatively high levels, are identified, the markdown analysis module 108 confirms whether the identified products in the outlier store are inelastic products as discussed above. According to one embodiment, the markdown analysis module 108 analyzes the price, markdown, and sales information of the identified products in the outlier store at predefined intervals. For example, according to one embodiment, the markdown analysis module 108 analyzes the price, markdown, and sales information of the identified products in the outlier store on a weekly basis; however, in other embodiments, the markdown analysis module 108 may be configured to analyze the price, markdown, and sales of the identified products in the outlier store at any defined intervals.

The markdown analysis module 108 analyzes the price, markdown, and sales of at least one of the identified products within the outlier store at the predefined intervals (e.g., on a weekly basis) and based on the price, markdown, and sales information of the identified product, determines if the identified product in the outlier store is an inelastic product. For example, if the markdown analysis module 108 determines that a decrease in price (i.e., an increase in markdown) of an identified product in the outlier store has not increased sales of the identified product to a corresponding expected level, the markdown analysis module 108 identifies the identified product in the outlier store as an inelastic product, the sales of which are largely unaffected by its markdown level. As discussed above, Applicant has appreciated that as the sales of an inelastic product are relatively not affected by a price markdown (no matter its level), the sales of the inelastic product will remain relatively the same even if the price markdown is reduced or eliminated. Accordingly, by reducing (or eliminating) the price markdown of the identified inelastic product, the relatively level sales of the inelastic product will produce a greater return to the retailer. For example, in one embodiment, the markdown level of an identified inelastic product in the outlier store (as discussed above) may be adjusted by the markdown analysis module 108 to a target price that will return greater value to the retail store without affecting the relatively stable sales of the “inelastic product”. Accordingly, by identifying inelastic products in the outlier store, the markdown analysis module 108 is able to recognize when a markdown of a product should be reduced to provide greater return to the retail store without affecting sales of the product.

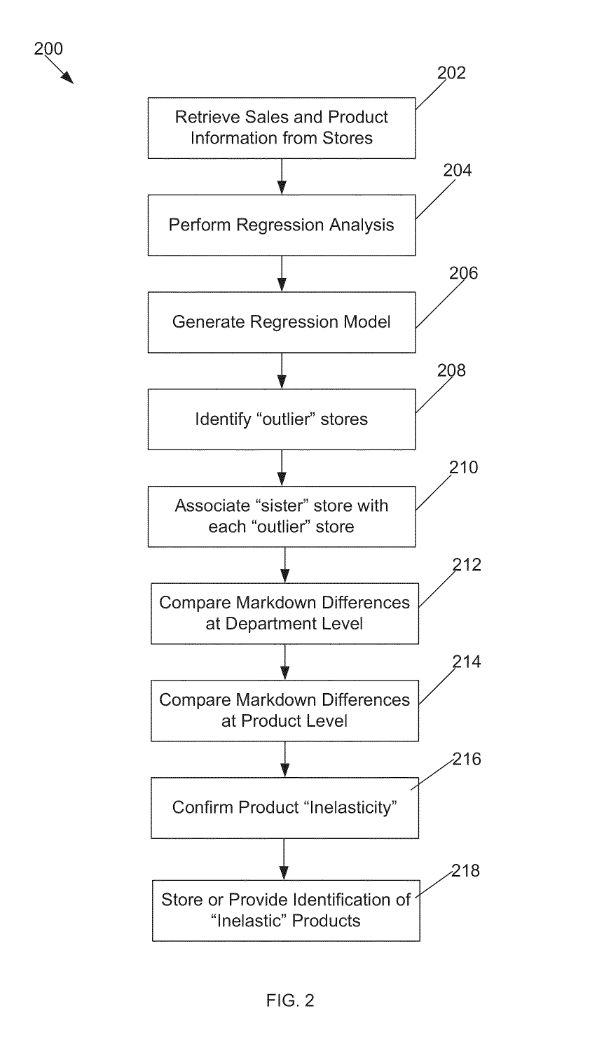

Operation of the markdown analysis module 108 is discussed in greater detail below with regard to FIGS. 2-8. FIG. 2 is a flow chart 200 illustrating a process for identifying inelastic products in a retail environment in accordance with at least one embodiment described herein. At block 202, the markdown analysis module 108 communicates with the store server 112 of each store 104(a-c) (e.g., via the network 106 and interfaces 114) to retrieve desired product and sales information from the database 114 of each store 104(a-c). As discussed above, the retrieved product and sales information may relate to products offered for sale within each store 104(a-c) and/or the actual sales of the products within each store 104(a-c).

At block 204, upon retrieving the desired product and sales information (related to the retail stores 104(a-c)), the markdown analysis module 108 performs a regression analysis for the expected markdown of each store 104(a-c) over a defined period of time based on multiple product and sales based factors of each store 104(a-c) that may impact or drive markdowns. For example, according to one embodiment, the markdown analysis module 108 performs a regression analysis for the expected markdown each store 104(a-c) with product and sales based factors such as total sales, feature sales, sales coefficient of variation (standard deviation/mean of weekly store sales), inventory turns, number of items in the store, the number of items actually sold, the percentage of sales that are grocery sales, or any other product or sales based factor which may affect markdowns of a store.

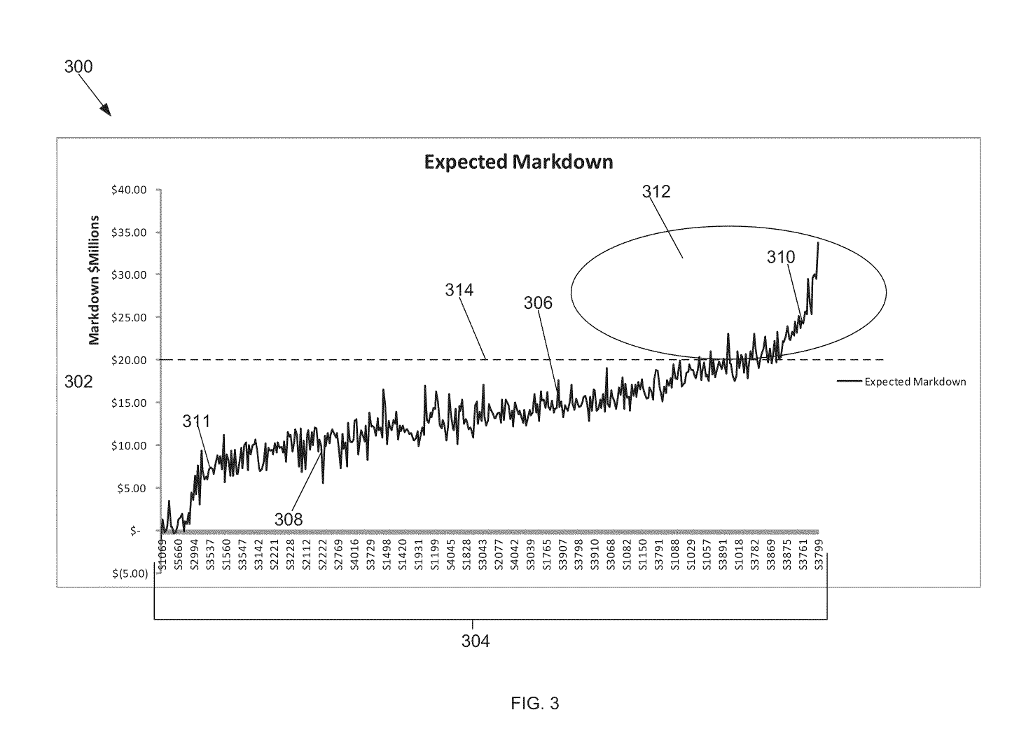

At block 206, upon performing the regression analysis with multiple product and sales based factors for the expected markdown of each store 104(a-c), the markdown analysis module 108 generates a regression model of the total expected markdown of each store 104(a-c) over the defined period of time. For example, FIG. 3 illustrates a regression model 300 resulting from a regression analysis for the expected markdown of each store of a group of stores over a defined period of time based on multiple product and sales based factors of each store. The y-axis 302 of the regression model 300 represents expected markdown (in millions of dollars) and the x-axis of the regression model 300 represents the stores 304 which were analyzed in the regression analysis. As illustrated, the regression model 300 includes forty-two stores 304; however, in other embodiments, any number of stores may be analyzed.

The regression line 306 represents the total expected markdown (in millions of dollars) of each store 304. For example, according to the regression line 306, the store 308 having an ID of S2222 has an expected markdown 306 of around 9.9 million dollars and the store 310 having an ID of S3761 has an expected markdown 306 of around 24.6 million dollars.

At block 208, based on the calculated total expected markdown 306 of each store 104(a-c) (as seen in the regression line 306), the markdown analysis module 108 identifies a group of outlier stores 312 (i.e., a store 304 with an expected total markdown 306 that is higher than the expected total markdown of a majority of the other stores 304 in the group). For example, as seen in FIG. 3, the selected outlier stores 312 each have an expected total markdown level that is greater than an expected total markdown threshold 314. Alternatively, the majority of stores 304 not in the group of selected outlier stores 312 each have an expected total markdown level 306 that is below the expected total markdown threshold 314. According to one embodiment, the expected total markdown threshold 314 is twenty million dollars in expected markdown; however, the expected total markdown threshold 314 may be defined at any expected total markdown level. Also according to one embodiment, the group of selected outlier stores 312 is defined to include a relatively small percentage of the total number of stores 304 in the regression model 300; however, in other embodiments, any number of stores may be included in the group of selected outlier stores 312.

At block 210, upon identifying a group of outlier stores 312, the markdown analysis module 108 identifies a sister store 311 for each outlier store 312. According to one embodiment, a sister store 311 to an outlier store 312 is a store 304 that has similar sales and similar characteristics (e.g., similar qualitative factors such as the same customer profiles, size, demographics, area per capita earnings, etc) to an outlier store 312 but less expected total markdown 306 than the outlier store 312. For example, according to one embodiment, the markdown analysis module 108 identifies that the store having an ID of S3537 is a sister store 311 of the outlier store 310 having an ID of S3761 as the sister store 311 has similar sales and/or characteristics to the outlier store 310 but less expected total markdown 306 (e.g., around 7.1 million dollars in total expected markdown 306 vs. around 24.6 million dollars in total expected markdown 306). According to some embodiments, any number of outlier/sister store pairs may be defined within the group of analyzed stores 304. Also, according to some embodiments, the outlier/sister store pairs may be defined to include any appropriate outlier store 312 and sister store 311 combinations.

At block 212, after identifying a group of outlier stores and an associated sister store for each outlier store, the markdown analysis module 108 compares the differences in markdowns between the outlier and sister stores at a department level to identify “departments of opportunity”. According to one embodiment, a “department of opportunity” is a store department within which the difference between the expected markdown of the outlier store and the expected markdown of the sister store is at a relatively high level as compared to other store departments.

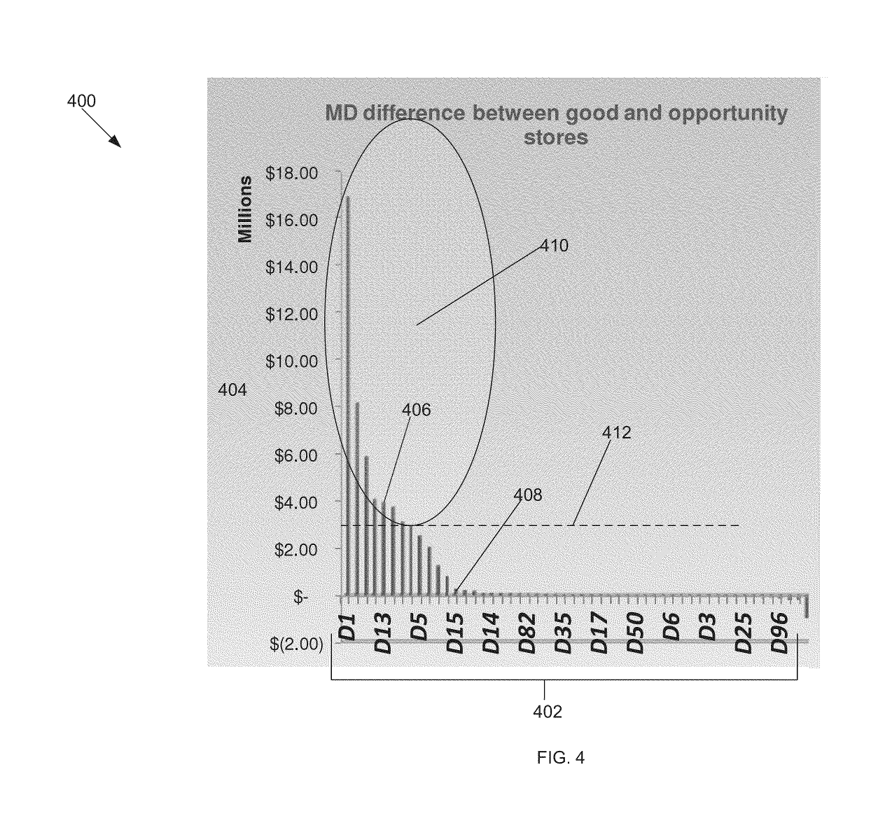

For example, FIG. 4 is a graph 400 illustrating the differences between the expected markdown of an outlier store (e.g., outlier store 310 illustrated in FIG. 3) and the expected markdown of a sister store (e.g., sister store 311 illustrated in FIG. 3) within different store departments 402 of the outlier and sister stores. The x-axis of the graph represents the different analyzed store departments 402 within the outlier 312 and sister 311 stores. According to one embodiment, the graph 400 illustrates thirteen analyzed store departments 402; however, in other embodiments, any number of store departments 402 within the outlier 312 and sister 311 stores may be analyzed.

The y-axis 404 of the graph 400 represents the difference (in millions of dollars) between the expected markdown of an outlier store and the expected markdown of a sister store within a store department 402. For example, according to one embodiment as shown in FIG. 4, the difference 406 between the expected markdown of an outlier store and the expected markdown of a sister store within a store department 402 having an ID of D13 is around 3.9 million dollars and the difference 408 between the expected markdown of an outlier store and the expected markdown of a sister store within a store department 402 having an ID of D15 is around 253k dollars.

According to one embodiment, the markdown analysis module 108 identifies store departments 402 in which the difference between the expected markdown of an outlier store and the expected markdown of a sister store is relatively high (i.e., above a department level expected markdown threshold 412) as “departments of opportunity” 410. According to one embodiment, as illustrated in FIG. 4, the department level expected markdown threshold 412 is defined as around three million dollars. In such an embodiment, the store department 402 with an ID of D13 (having an expected markdown difference 406 between stores of 3.9 million dollars) is considered a “department of opportunity” 410. However, according to other embodiments, the department level expected markdown threshold 412 may be defined at any level.

As discussed above, Applicant has appreciated that the differences in markdowns between an outlier store and a sister store at a department level generally follows Pareto's Principle in that eighty percent of the total difference in markdowns between an outlier store and a sister store is accounted for in only twenty percent of the store departments 402 (i.e., in the “departments of opportunity 410). Accordingly, in at least some embodiments, by identifying departments in the two stores within which the markdown difference is at relatively high level (i.e., “departments of opportunity” 410), the markdown analysis module 108 is able to account for a majority of the total difference in markdowns between the outlier store and the sister store at the department level. However, in other embodiments, the differences in markdowns between an outlier store and a sister store at a department level may not follow Pareto's Principle. In such an embodiment, the percentage of departments 402 included in the “departments of opportunity” 410 may be more or less than twenty percent of the store departments 402.

At block 214, upon identifying at least one “department of opportunity” 410, the markdown analysis module 108 identifies products within a “department of opportunity” 410 at which the difference between the expected markdown of the outlier store and the expected markdown of the sister store is at a relatively high level as compared to other products within the “department of opportunity” 410.

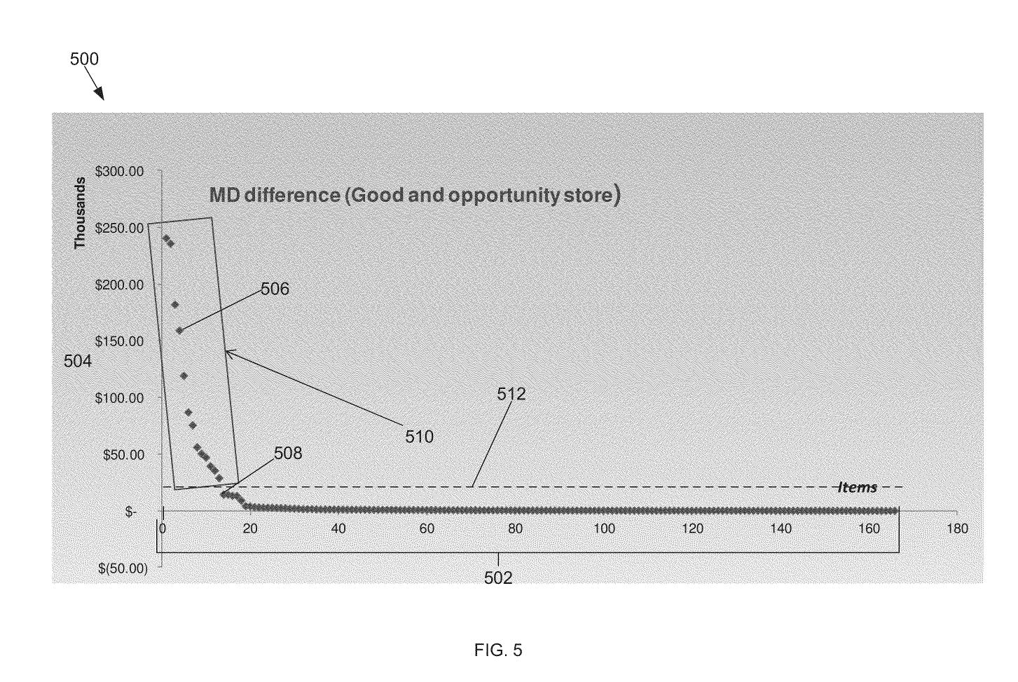

For example, FIG. 5 is a graph 500 illustrating the differences between the expected markdown of products within a “department of opportunity” 410 of an outlier store (e.g., outlier store 310 illustrated in FIG. 3) and the expected markdown of products within a “department of opportunity” 410 of a sister store (e.g., sister store 311 illustrated in FIG. 3). The x-axis of the graph represents the different analyzed products 502 within the “department of opportunity” 410 of the outlier 312 and sister 311 stores. According to one embodiment, the graph 500 illustrates over 160 analyzed products 502; however, in other embodiments, any number of products 502 within a “department of opportunity” of the outlier 312 and sister 311 stores may be analyzed.

The y-axis 504 of the graph 500 represents the difference (in thousands of dollars) between the expected markdown of a product within an outlier store and the expected markdown of a product within a sister store. For example, according to one embodiment as shown in FIG. 5, the difference 506 between the expected markdown of one product in an outlier store and the expected markdown of the same product in a sister store is around 160k dollars and the difference 508 between the expected markdown of another product in the outlier store and the expected markdown of the same product in the sister store is around 15k dollars.

According to one embodiment, the markdown analysis module 108 identifies products 510 in the “department of opportunity” 410 in which the difference between the expected markdown of the product in the outlier store and the expected markdown of the product in the sister store is relatively high (i.e., above a product level expected markdown threshold 512). According to one embodiment, as illustrated in FIG. 5, the product level expected markdown threshold 512 is defined as around 25k dollars. In such an embodiment, the product with the markdown difference 506 of 160k dollars, discussed above, is considered one of the products 510 in the “department of opportunity” 410 at which the difference between the expected markdown of the product in the outlier store and the expected markdown of the product in the sister store is relatively high. However, according to other embodiments, the product level expected markdown threshold 512 may be defined at any level.

As discussed above, Applicant has also appreciated that the difference in markdowns between products within a “department of opportunity” 410 of an outlier store and a sister store generally follows Pareto's Principle in that eighty percent of the total markdown difference between products of an outlier store and products of a sister store (within the “department of opportunity”) is accounted for in only twenty percent of the products 502 within the “department of opportunity” 410. Accordingly, in at least some embodiments, by identifying products 510 in the “department of opportunity” 410 at which the markdown differences between the two stores are at relatively high levels, the markdown analysis module 108 is able to account for a majority of the total difference in markdowns between products of the outlier store and the sister store within the “department of opportunity” 410. However, in other embodiments, the difference in markdowns between products of an outlier store and products of a sister store within a “department of opportunity” 410 may not follow Pareto's Principle. In such an embodiment, the percentage of products 502 at which the markdown differences between the two stores are considered at relatively high levels may be more or less than twenty percent.

At block 216, once the products in the “department of opportunity” 410 at which the markdown differences between the two stores are at relatively high levels (i.e., are above the product level expected markdown threshold 512) are identified, the markdown analysis module 108 confirms whether the identified products 510 in the outlier store (e.g., outlier store 310 illustrated in FIG. 3) are inelastic products as discussed above. According to one embodiment, the markdown analysis module 108 analyzes the price, markdown, and sales information of the identified products in the outlier store at predefined intervals. For example, according to one embodiment, the markdown analysis module 108 analyzes the price, markdown, and sales information of the identified products in the outlier store on a weekly basis; however, in other embodiments, the markdown analysis module 108 may be configured to analyze the price, markdown, and sales of the identified products in the outlier store at any defined intervals.

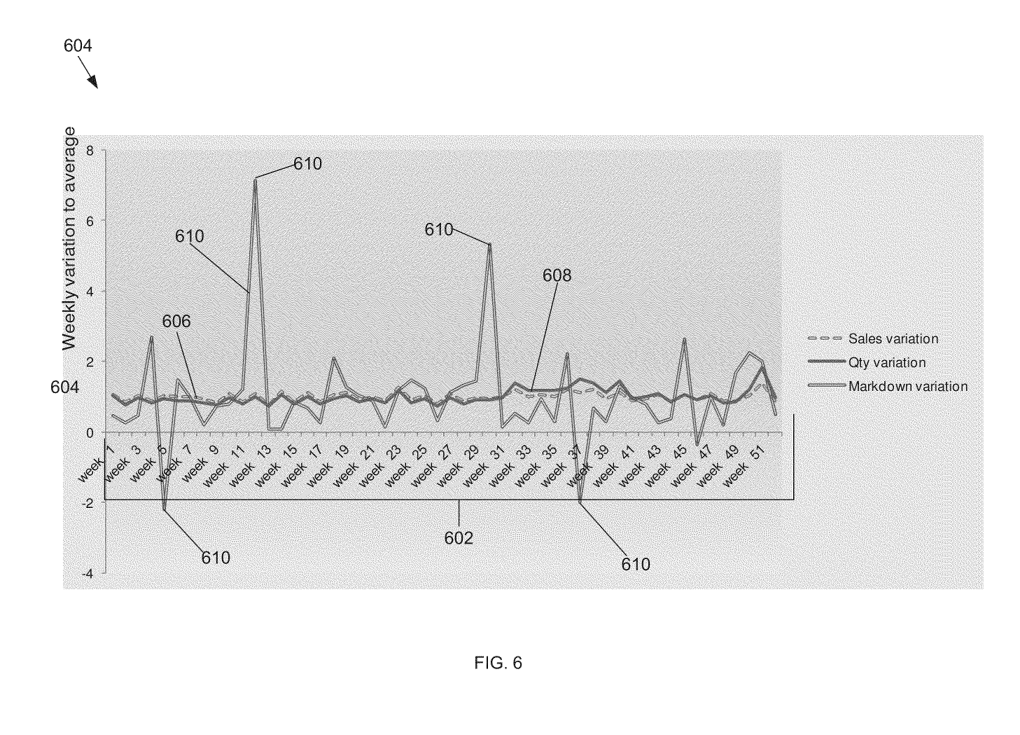

For example, FIG. 6 is a graph 600 illustrating an analysis, performed by the markdown analysis module 108, of average sales, average quantity sold, and average markdown of one of the products 510 in the “department of opportunity”410 at which the markdown difference between an outlier store and a sister store is at a relatively high level. The x-axis 602 of the graph 600 is a timeline representing the different intervals of time at which the markdown analysis module 108 analyzes the average sales, average quantity sold, and average markdown information of the product. According to one embodiment, the markdown analysis module 108 analyzes the information on a weekly basis (as illustrated in FIG. 6); however, in other embodiments, the intervals may be defined differently.

The y-axis 604 of the graph 600 represents the weekly variation to the average of each variable analyzed by the markdown analysis module 108 (e.g., to the average sales of the product, the average quantity of the products sold, and/or the average markdown of the product). The line 606 represents the weekly variation to the average sales of the product. The line 608 represents the weekly variation to the average quantity of the products sold. The line 610 represents the weekly variation to the markdown of the product. In other embodiments, the markdown analysis module 108 may analyze additional variables related to the product that may impact the sales of the product.

According to one embodiment, based on the weekly variation of the average sales of the product, the average quantity of the products sold, and/or the average markdown of the product (e.g., as seen in FIG. 6), the markdown analysis module 108 determines if the product in the outlier store is an inelastic product. According to one embodiment, if the markdown analysis module 108 determines that a decrease in price (i.e., an increase in markdown) of an identified product in the outlier store has not increased sales of the identified product to a corresponding expected level, the markdown analysis module 108 identifies the product in the outlier store as an inelastic product, the sales of which are largely unaffected by its markdown level.

For example, according to one embodiment, as seen in FIG. 6, at certain times (e.g., in week five, twelve, thirty, and thirty-seven) the average markdown 610 of the product is either significantly increased or decreased. However, also at these times, the average sales 606 and quantity sold 608 of the product remains relatively the same, despite the increase or decrease in markdown. As such, the markdown analysis module 108 identifies that the product analyzed in FIG. 6 is an inelastic product in that its sales are largely unaffected by its markdown level.

At block 218, upon identifying at least one inelastic product within the outlier store, the markdown analysis module 108 either stores the identification of the inelastic product(s) in its database 110, transmits the identification of the inelastic product(s) to the store server 112 and/or database 114 of the outlier store, transmits the identification of the inelastic product(s) to the store server 112 and/or database 114 of another store 104(a-c), or transmits the identification of the inelastic product(s) to another external system (e.g., an administration system).

As discussed above, Applicant has appreciated that as the sales of an inelastic product are relatively not affected by a price markdown (no matter its level), the sales of an inelastic product will remain relatively the same even if the price markdown is reduced or eliminated.

Accordingly, by reducing (or eliminating) the price markdown of an identified inelastic product, the relatively level sales of the inelastic product will produce a greater return to the retailer. For example, in one embodiment, the markdown level of an identified inelastic product in the outlier store (as discussed above) may be adjusted by the markdown analysis module 108 to a target price that will return a greater value to the retail store without affecting the relatively stable sales of the inelastic product.

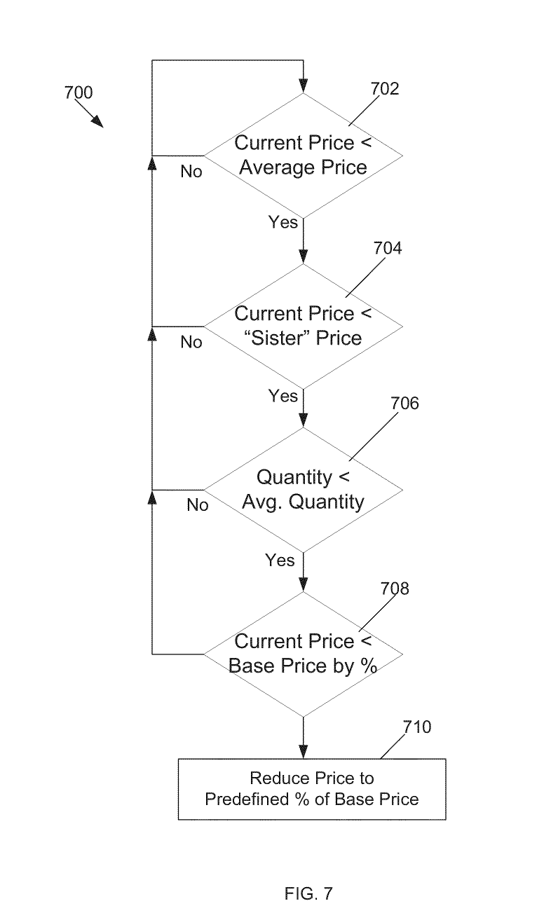

For example, FIG. 7 is a flow chart 700 illustrating one embodiment of a process for adjusting the price of an identified inelastic product within an outlier store. At block 702, the markdown analysis module 108 determines if the current price of the inelastic product within the outlier store is less than the average price of the product across the group of stores to which the markdown analysis module 108 is in communication (e.g., retail stores 104(a-c) as illustrated in FIG. 1). According to one embodiment, the average price is calculated over a minimum period of time (e.g., 3 weeks); however, in other embodiments, the average price may be calculated over any defined period of time. According to one embodiment, in response to a determination that the current price of the inelastic product is not less than the average price of the product, at block 702 the markdown analysis module 108 continues to monitor the current price of the inelastic product and the average price of the product to determine whether the current price of the inelastic product is less than the average price of the product.

At block 704, in response to a determination that the current price of the inelastic product is less than the average price of the product, the markdown analysis module 108 determines if the current price of the inelastic product within the outlier store is less than the current price of the product in the outlier store's sister store. According to one embodiment, in response to a determination that the current price of the inelastic product is not less than the current price of the product in the sister store, at block 702 the markdown analysis module 108 again monitors the current price of the inelastic product and the average price of the product to determine whether the current price of the inelastic product is less than the average price of the product.

At block 706, in response to a determination that the current price of the inelastic product is less than the current price of the product in the sister store, the markdown analysis module 108 determines if the number of inelastic products sold by the outlier store over a period of time is less than the average number of products sold by the group of stores (e.g., retail stores 104(a-c)) to which the markdown analysis module 108 is in communication.

According to one embodiment, the period of time is defined as three weeks; however, in other embodiments, the period of time may be defined differently. According to one embodiment, in response to a determination that the number of inelastic products sold by the outlier store over the defined period of time is not less than the average number of sold products, at block 702 the markdown analysis module 108 again monitors the current price of the inelastic product and the average price of the product to determine whether the current price of the inelastic product is less than the average price of the product.

At block 708, in response to a determination that the number of inelastic products sold in the outlier store is less than the average number of products sold, the markdown analysis module 108 determines if the current price of the inelastic product is less than a base price by at least a predefined percentage. According to one embodiment, the percentage is ninety percent; however, in other embodiments, the percentage may be defined differently. According to one embodiment, a base price is a predetermined price for the inelastic product set by an administrator of the retail environment. In one embodiment, the base price is set by an administrator at an external unit, transmitted to the central server 102 via the network 106, and stored in the database 110. In another embodiment, the base price is set by an administrator at an interface of the central server 102. The base price may be maintained in the database 110 of the central server and/or transmitted to the store servers 108 and databases 114 of the retail stores 104(a-c).

According to one embodiment, in response to a determination that the current price of the inelastic product in the outlier store is not less than the base price by at least the predefined percentage, at block 702 the markdown analysis module 108 again monitors the current price of the inelastic product and the average price of the product to determine whether the current price of the inelastic product is less than the average price of the product.

At block 710, in response to a determination that the current price of the inelastic product in the outlier store is less than the base price by at least the predefined percentage (e.g., ninety percent), the markdown analysis module 108 increases the current price of the “inelastic product” (i.e., reduces the markdown) to a recommended (or target) level which is less than the base price by the predefined percentage (e.g., ninety percent as discussed above). According to one embodiment, the markdown analysis module 108 adjusts the price of the “inelastic product” by transmitting instructions to the store server 112 and/or database 114 of the outlier store to automatically change the current price of the inelastic product in the outlier store to the recommended level. In another embodiment, the markdown analysis module 108 adjusts the price of the “inelastic product” by transmitting instructions to the outlier store that the price of the “inelastic product” should be adjusted to the recommended level.

By adjusting the price of the inelastic product (i.e., reducing the markdown) to a recommended (or target) level which is closer to the base price of the inelastic product, greater return may be provided to the retail store from relatively stable sales of the product that are unaffected by the change in markdown price.

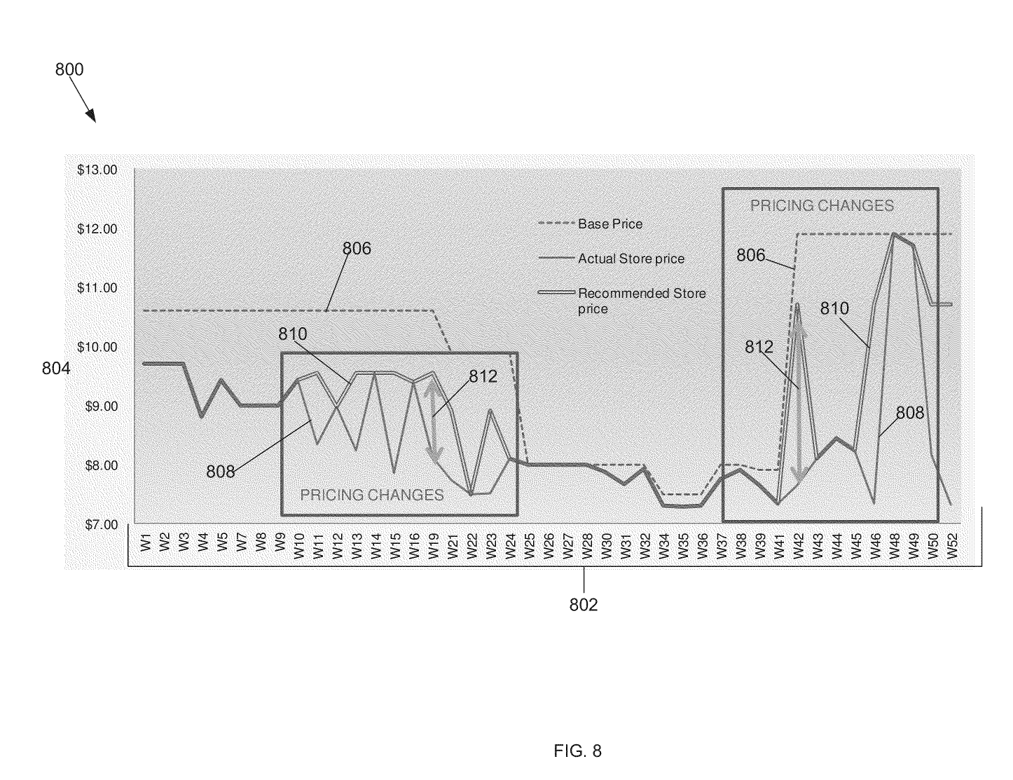

For example, FIG. 8 is graph 800 illustrating the impact markdown reduction of an inelastic product may have on the return of an outlier store from sales of the inelastic product. The x-axis 802 of the graph 800 is a timeline representing the different intervals of time at which the markdown analysis module 108 may analyze the current price of an identified inelastic product. According to one embodiment, the markdown analysis module 108 analyzes the current price of an identified inelastic product on a weekly basis (as illustrated in FIG. 8); however, in other embodiments, the intervals may be defined differently. The y-axis 804 of the graph 800 represents price in dollars. The line 806 represents the base price of the inelastic product (as discussed above). The line 808 represents the actual current price of the inelastic product. The line 810 represents the recommended (or target) price of the inelastic product (e.g., a predefined percentage less than the base price 806 as discussed above).

According to one embodiment as shown in FIG. 8, at weeks nine and thirty-seven, the markdown analysis module 108 begins to analyze the current actual price 810 of an inelastic product (identified as discussed above with regard to FIG. 2) to determine if the current actual price 810 should be adjusted closer to the base price 806. For example, according to one embodiment, as described above with regard to FIG. 7, the markdown analysis module 108 confirms whether the current actual price 810 of the identified inelastic product is less than the average price of the inelastic product, whether the current actual price 810 of the inelastic product is less than the price of the inelastic product in the outlier store's sister store, whether the quantity of inelastic products sold by the outlier store is less than the average quantity of inelastic products sold, and whether the actual current price 810 of the inelastic property is less than the base price 806 by at least a predefined percentage (e.g., ninety percent). As described above, if each one of these conditions is met, the markdown analysis module 108 determines that the current actual price 810 of the inelastic product should be adjusted closer to the base price 806 (e.g., only less than the base price 806 by the predefined percentage (e.g., ninety percent)). According to other embodiments, the markdown analysis module 108 may be configured to determine that the current actual price 810 of the inelastic product should be adjusted in response to other price and/or quantity conditions.

As illustrated in FIG. 8, if the markdown analysis module 108 controls the actual price 808 of the inelastic product to rise to the level of at least a predefined percentage of the base price (i.e., the recommended or target price 810), the difference 804 in the recommended price and the current actual price 808 is the increased return that the outlier store will see for sales made of the inelastic product at the outlier store after the price of the “inelastic product” is increased (i.e., the markdown is decreased). Accordingly, by reducing the markdown of an identified inelastic product at an outlier store, as discussed above, greater return can be provided to the outlier store without impacting the sales of the inelastic product. Various embodiments according to the present invention may be implemented on one or more computer systems or other devices. A computer system may be a single computer that may include a minicomputer, a mainframe, a server, a personal computer, or combination thereof. The computer system may include any type of system capable of performing remote computing operations (e.g., cell phone, PDA, tablet, smart-phone, set-top box, or other system). A computer system used to run the operation may also include any combination of computer system types that cooperate to accomplish system-level tasks. Multiple computer systems may also be used to run the operation. The computer system also may include input or output devices, displays, or data storage units. It should be appreciated that any computer system or systems may be used, and the invention is not limited to any number, type, or configuration of computer systems.

These computer systems may be, for example, general-purpose computers such as those based on Intel PENTIUM-type processor, Motorola PowerPC, Sun UltraSPARC, Hewlett-Packard PA-RISC processors, or any other type of processor. It should be appreciated that one or more of any type computer system may be used to partially or fully automate operation of the described system according to various embodiments of the invention. Further, the system may be located on a single computer or may be distributed among a plurality of computers attached by a communications network.

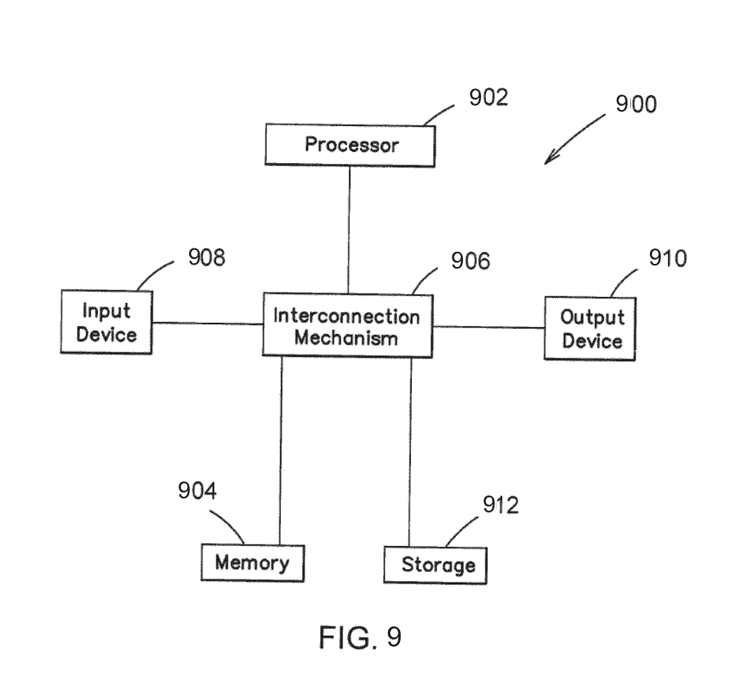

For example, various aspects of the invention may be implemented as specialized software executing in a general-purpose computer system 900 such as that shown in FIG. 9. The computer system 900 may include a processor 902 connected to one or more memory devices (i.e., data storage) 904, such as a disk drive, memory, or other device for storing data. Memory 904 is typically used for storing programs and data during operation of the computer system 900. Components of computer system 900 may be coupled by an interconnection mechanism 906, which may include one or more busses (e.g., between components that are integrated within a same machine) and/or a network (e.g., between components that reside on separate discrete machines). The interconnection mechanism 906 enables communications (e.g., data, instructions) to be exchanged between system components of system 900.

Computer system 900 also includes one or more input devices 908, for example, a keyboard, mouse, trackball, microphone, touch screen, and one or more output devices 910, for example, a printing device, display screen, and/or speaker. In addition, computer system 900 may contain one or more interfaces (not shown) that connect computer system 900 to a communication network (in addition or as an alternative to the interconnection mechanism 906).

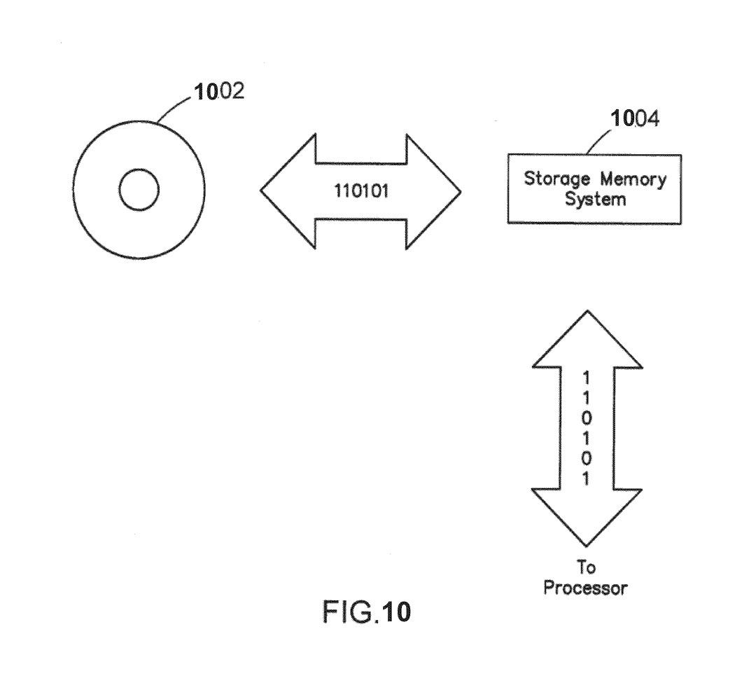

The storage system 912, shown in greater detail in FIG. 10, typically includes a computer readable and writeable nonvolatile recording medium 1002 in which signals are stored that define a program to be executed by the processor or information stored on or in the medium 1002 to be processed by the program. The medium may, for example, be a disk or flash memory. Typically, in operation, the processor causes data to be read from the nonvolatile recording medium 1002 into another memory 1004 that allows for faster access to the information by the processor than does the medium 1002. This memory 1004 is typically a volatile, random access memory such as a dynamic random access memory (DRAM) or static memory (SRAM). It may be located in storage system 912, as shown, or in memory system 904. The processor 902 generally manipulates the data within the integrated circuit memory 904, 1004 and then copies the data to the medium 1002 after processing is completed. A variety of mechanisms are known for managing data movement between the medium 1002 and the integrated circuit memory element 904, 1004, and the invention is not limited thereto. The invention is not limited to a particular memory system 904 or storage system 912.

The computer system may include specially-programmed, special-purpose hardware, for example, an application-specific integrated circuit (ASIC). Aspects of the invention may be implemented in software, hardware or firmware, or any combination thereof. Further, such methods, acts, systems, system elements and components thereof may be implemented as part of the computer system described above or as an independent component.

Although computer system 900 is shown by way of example as one type of computer system upon which various aspects of the invention may be practiced, it should be appreciated that aspects of the invention are not limited to being implemented on the computer system as shown in FIG. 9. Various aspects of the invention may be practiced on one or more computers having a different architecture or components that that shown in FIG. 9.

Computer system 900 may be a general-purpose computer system that is programmable using a high-level computer programming language. Computer system 900 may be also implemented using specially programmed, special purpose hardware. In computer system 900, processor 902 is typically a commercially available processor such as the well-known Pentium class processor available from the Intel Corporation. Many other processors are available. Such a processor usually executes an operating system which may be, for example, the Windows 95, Windows 98, Windows NT, Windows 2000 (Windows ME), Windows XP, Windows Visa, Windows 7, or Windows 8 operating systems available from the Microsoft Corporation, MAC OS System X operating system or an iOS operating system available from Apple Computer, one of many Linux-based operating system distributions, for example, the Enterprise Linus operating system available from Red Hat Inc., or UNIX available from various sources. Many other operating systems may be used.

The processor and operating system together define a computer platform for which application programs in high-level programming languages are written. It should be understood that the invention is not limited to a particular computer system platform, processor, operating system, or network. Also, it should be apparent to those skilled in the art that the present invention is not limited to a specific programming language or computer system. Further, it should be appreciated that other appropriate programming languages and other appropriate computer systems could also be used.

One or more portions of the computer system may be distributed across one or more computer systems (not shown) coupled to a communications network. These computer systems also may be general-purpose computer systems. For example, various aspects of the invention may be distributed among one or more computer systems configured to provide a service (e.g., servers) to one or more client computers, or to perform an overall task as part of a distributed system. For example, various aspects of the invention may be performed on a client-server system that includes components distributed among one or more server systems that perform various functions according to various embodiments of the invention. These components may be executable, intermediate (e.g., IL) or interpreted (e.g., Java) code which communicate over a communication network (e.g., the Internet) using a communication protocol (e.g., TCP/IP).

It should be appreciated that the invention is not limited to executing on any particular system or group of systems. Also, it should be appreciated that the invention is not limited to any particular distributed architecture, network, or communication protocol. Various embodiments of the present invention may be programmed using an object-oriented programming language, such as SmallTalk, Java, C++, Ada, or C# (C-Sharp). Other object-oriented programming languages may also be used. Alternatively, functional, scripting, and/or logical programming languages may be used. Various aspects of the invention may be implemented in a non-programmed environment (e.g., documents created in HTML, XML or other format that, when viewed in a window of a browser program, render aspects of a graphical-user interface (GUI) or perform other functions). Various aspects of the invention may be implemented as programmed or non-programmed elements, or any combination thereof.

As described above, the retail environment includes three stores 104(a-c); however, in other embodiments, the retail environment may include any number of stores.

As described above, the system for identifying inelastic products is utilized in a retail environment; however, in other embodiments the system for identifying inelastic products may be utilized in any other type of commercial environment where it is desired to identify inelastic products and/or services.

As described above, according to some embodiments, the markdown analysis module 108 is configured to transmit instructions to an outlier store to automatically update the price of an inelastic product at the outlier store. According to at least one embodiment, the markdown analysis module 108 is configured to automatically update the prices of identified inelastic products at the outlier store in real-time (i.e., as soon as the markdown analysis module 108 identifies an inelastic product and determines that the price of the inelastic product should be adjusted). In another embodiment, the markdown analysis module 108 is configured to update the prices of identified inelastic products at the outlier store only at predetermined times.

As described above, according to one embodiment, the markdown analysis module 108 performs inelastic product identification as well as markdown price adjustment analysis. However, in at least one embodiment, the markdown price adjustment analysis is performed by a separate price adjustment module 109 within the central server 102 or in a store server108 that is in communication with the markdown analysis module via the network 106 or a LAN.

As described above, it is generally difficult for a retailer to adequately set an appropriate time, duration, and/or level of a markdown of an item to ensure that the markdown will successfully drive sales of the item. This problem is exacerbated if the product is inelastic.

For example, it is typically difficult for a retailer to determine if a markdown is “good” or “bad” (i.e., affective in driving the sale of a product or not). Accordingly, by comparing markdowns of an outlier store to a sister store with similar characteristics (as discussed above), a retailer may be able to quantitatively determine whether products within the outlier store are inelastic and hence whether the markdowns of the inelastic products in the outlier store are actually bad markdowns. In addition, by identifying inelastic products (and bad markdowns), the retailer may also be able to adjust the markdown of the inelastic products (as also discussed above) to provide greater return to the outlier store without affecting sales of the inelastic products.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A system for identifying inelastic products in a retail environment, the system comprising:
an interface configured to be coupled to a communication network;
a markdown analysis module coupled to the interface and configured to communicate with a server of each one of a plurality of retail stores in the retail environment via the interface and the communication network; and
a database coupled to the markdown analysis module;
wherein the markdown analysis module is further configured to:
receive signals from each server of the plurality of retail stores including information related to product sales in each one of the plurality of retail stores;
calculate, based on the received product sales information, the total expected markdown over a period of time for each one of the plurality of retail stores;
identify, based on the total expected markdown of each one of the plurality of retail stores, an outlier store from the plurality of retail stores that has a total expected markdown greater than a expected total markdown threshold;
identify a sister store from the plurality of retail stores that has at least one similar characteristic to the outlier store and a total expected markdown that is less than the total expected markdown of the outlier store;
compare expected markdown of the outlier store with expected markdown of the sister store; and
identify, based on the comparison between the expected markdown of the outlier store and the sister store, at least one inelastic product in the outlier store.

2. The system of claim 1, wherein the product sales information received by the markdown analysis module from each one of the plurality of retail stores includes at least one of product and sale based factors that impact the total expected markdown of the plurality of retail stores.

3. The system of claim 2, wherein in calculating the total expected markdown over the period of time for each one of the plurality of retail stores, the markdown analysis module is further configured to perform a regression analysis for the expected markdown of each one of the plurality of retail stores over the period of time based on the received product or sale based factors of each one of the plurality of stores.

4. The system of claim 1, wherein in comparing the expected markdown of the outlier store with the expected markdown of the sister store, the markdown analysis module is further configured to compare differences between expected markdown in a plurality of departments in the outlier store and expected markdown in the plurality of departments in the sister store.

5. The system of claim 4, wherein the markdown analysis module is further configured, based on the comparison of differences between the expected markdown in the plurality of departments in the outlier store and the expected markdown in the plurality of departments in the sister store, to identify a department of opportunity in which the difference between the expected markdown in the outlier store and the expected markdown in the sister store is greater than a department level expected markdown threshold.

6. The system of claim 5, wherein in comparing the expected markdown of the outlier store with the expected markdown of the sister store, the markdown analysis module is further configured to compare differences between expected markdown of products in the department of opportunity of the outlier store and expected markdown of products in the department of opportunity of the sister store.

7. The system of claim 6, wherein the markdown analysis module is further configured to identify at least one product, within the department of opportunity, at which the difference between expected markdown of the at least one product in the outlier store and the expected markdown of the at least one product in the sister store is greater than a product level expected markdown threshold.

8. The system of claim 7, wherein the markdown analysis module is further configured to confirm whether the at least one product in the outlier store is inelastic.

9. The system of claim 8, wherein in confirming whether the at least one product in the outlier store is inelastic, the markdown analysis module is further configured to analyze at least one of total sales information of the at least one product in the outlier store and quantity sold information of the at least one product in the outlier store in relation to markdown information of the at least one product in the outlier store.

10. The system of claim 9, wherein the markdown analysis module is further configured to identify the at least one product as inelastic in response to a determination that the markdown information of the at least one product in the outlier store is relatively unaffected by either the sales information or the quantity sold information of the at least one product in the outlier store.

11. The system of claim 10, wherein the markdown analysis module is further configured to adjust a current markdown of the at least one product in the outlier store to a target level in response to a determination that the at least one product is inelastic.

12. The system of claim 11, wherein the markdown analysis module is further configured to adjust a current price of the at least one product in the outlier store to a level that is a predefined percentage less than a preprogrammed base price of the at least one product.

13. The system of claim 11, wherein the markdown analysis module is further configured to transmit signals, via the interface, to the server of the outlier store to adjust the current markdown of the at least one product to the target level.

14. The system of claim 11, wherein the markdown analysis module is further configured to adjust, in real time, the current markdown of the at least one product in the outlier store to a target level in response to the determination that the at least one product is inelastic.

15. The system of claim 10, further comprising a price adjustment module coupled to the interface and the markdown analysis module and configured to communicate with the server of each one of the plurality of retail stores in the retail environment via the interface and to adjust a current markdown of the at least one product in the outlier store to a target level in response to a determination, by the markdown analysis module, that the at least one product is inelastic.

16. A method for identifying inelastic products in a retail environment, the method comprising:
receiving, by a markdown analysis module from a server of each one of a plurality of retail stores in the retail environment via an interface, signals from each server of the plurality of retail stores including information related to product sales in each one of the plurality of retail stores;
calculating, with the markdown analysis module, based on the received product sales information, the total expected markdown over a period of time for each one of the plurality of retail stores;
identifying, with the markdown analysis module based on the total expected markdown of each one of the plurality of retail stores, an outlier store from the plurality of retail stores that has a total expected markdown greater than a expected total markdown threshold;
identifying, with the markdown analysis module, a sister store from the plurality of retail stores that has at least one similar characteristic to the outlier store and a total expected markdown that is less than the total expected markdown of the outlier store;
comparing, with the markdown analysis module, expected markdown of the outlier store with expected markdown of the sister store; and
identifying, with the markdown analysis module based on the comparison between the expected markdown of the outlier store and the sister store, at least one inelastic product in the outlier store.

17. The method of claim 16, wherein calculating the total expected markdown over the period of time for each one of the plurality of retail stores includes generating, with the markdown analysis module, a regression model for the expected markdown of each one of the plurality of retail stores over the period of time based on the received product sales information of each one of the plurality of stores, and utilizing the regression model to determine the total expected markdown over the period of time for each one of the plurality of retail stores.

18. The method of claim 16, wherein comparing the expected markdown of the outlier store with the expected markdown of the sister store includes comparing, with the markdown analysis module, differences between expected markdown in a plurality of departments in the outlier store and expected markdown in the plurality of departments in the sister store.

19. The method of claim 18, further comprising identifying, with the markdown analysis module based on comparing the differences between the expected markdown in the plurality of departments in the outlier store and the expected markdown in the plurality of departments in the sister store, a department of opportunity in which the difference between the expected markdown in the outlier store and the expected markdown in the sister store is greater than a department level expected markdown threshold.

20. The method of claim 19, wherein comparing the expected markdown of the outlier store with the expected markdown of the sister store includes comparing, with the markdown analysis module, differences between expected markdown of products in the department of opportunity of the outlier store and expected markdown of products in the department of opportunity of the sister store.

21. The method of claim 20, further comprising identifying, with the markdown analysis module, at least one product, within the department of opportunity, at which the difference between expected markdown of the at least one product in the outlier store and the expected markdown of the at least one product in the sister store is greater than a product level expected markdown threshold.

22. The method of claim 21, further comprising confirming, with the markdown analysis module, whether the at least one product in the outlier store is inelastic.

23. The method of claim 22, wherein confirming whether the at least one product in the outlier store is inelastic includes analyzing, with the markdown analysis module, at least one of total sales information of the at least one product in the outlier store and quantity sold information of the at least one product in the outlier store in relation to markdown information of the at least one product in the outlier store.

24. The method of claim 23, further comprising identifying, with the markdown analysis module, at least one product as inelastic in response to a determination that the markdown information of the at least one product in the outlier store is relatively unaffected by either the sales information or the quantity sold information of the at least one product in the outlier store.

25. The method of claim 24, further comprising adjusting a current markdown of the at least one product in the outlier store to a target level in response to a determination that the at least one product is inelastic.

26. The method of claim 25, wherein adjusting the current markdown of the at least one product in the outlier store to a target level includes adjusting a current price of the at least one product in the outlier store to a level that is a predefined percentage less than a preprogrammed base price of the at least one product.

27. The method of claim 25, wherein adjusting the current markdown of the at least one product in the outlier store to a target level includes transmitting signals, to the server of the outlier store, to adjust the current markdown of the at least one product to the target level.

28. The method of claim 25, wherein adjusting the current markdown of the at least one product to a target level is automatically performed in real time in response to the determination that the at least one product is inelastic.

29. A non-transitory computer-readable medium encoded with instructions for execution on a central server within a retail environment, the instructions when executed, performing a method comprising acts of:
receiving, by a markdown analysis module from a server of each one of a plurality of retail stores in the retail environment via an interface, signals from each server of the plurality of retail stores including information related to product sales in each one of the plurality of retail stores;
calculating, with the markdown analysis module, based on the received product sales information, the total expected markdown over a period of time for each one of the plurality of retail stores;
identifying, with the markdown analysis module based on the total expected markdown of each one of the plurality of retail stores, an outlier store from the plurality of retail stores that has a total expected markdown greater than a expected total markdown threshold;
identifying, with the markdown analysis module, a sister store from the plurality of retail stores that has at least one similar characteristic to the outlier store and a total expected markdown that is less than the total expected markdown of the outlier store;
comparing, with the markdown analysis module, expected markdown of the outlier store with expected markdown of the sister store; and
identifying, with the markdown analysis module based on the comparison between the expected markdown of the outlier store and the sister store, at least one inelastic product in the outlier store.
